(19) United States
(12) Patent Application Publication
(10) Pub. No.: US 2026/0003508 A1
(43) Pub. Date: Jan. 1, 2026

(54) PROTOCOL BETWEEN SYSTEMS AND DRIVES FOR CAPACITY MANAGEMENT

(71) Applicant: Seagate Technology LLC, Fremont, CA (US)

(72) Inventors: Nicholas James DANCE, Boulder, CO (US); Ian Robert DAVIES, Longmont, CO (US); Stephen S. HUH, Boulder, CO (US); Jon D. TRANTHAM, Chanhassen, MN (US); Riyan Alex MENDONSA, Edina, MN (US)

(21) Appl. No.: 18/759,635

(22) Filed: Jun. 28, 2024

(51) Int. Cl. G06F 3/06

(52) U.S. Cl. CPC G06F 3/0616; G06F 3/0619; G06F 3/0629; G06F 3/0644

(57) ABSTRACT

The technology disclosed herein provides a method including determining a location of a storage device in a storage enclosure, based on the location of a storage device in a storage enclosure, determining environmental associated with the location of the storage device, determining achievable capacity of the storage device based on the environmental parameters associated with the location of the storage device, and formatting the storage device based on the determined achievable capacity.

### BACKGROUND

Storage devices, such as disc drives are provisioned to withstand the worst-case scenarios. For example, a disc drive may be formatted to provide adequate performance and reliability in worst case temperature, vibration, etc. As a result, in the ordinary working conditions, which are generally not the worst-case conditions, the disc drives may be operating sub-optimally or with lower efficiency. For example, formatting the disc drive for the worst-case scenario may result in areal density capacity (ADC) of the disc drive to be significantly lower than maximum potential in ordinary operating conditions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

The technology disclosed herein provides a method including determining a location of a storage device in a storage enclosure, based on the location of a storage device in a storage enclosure, determining environmental associated with the location of the storage device, determining achievable capacity of the storage device based on the environmental parameters associated with the location of the storage device, and formatting the storage device based on the determined achievable capacity.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example schematic diagram of a system disclosed herein for providing a protocol between the system and the drives for capacity management.

FIG. 2 illustrates example operations of the system disclosed herein for providing a protocol between the system and the drives for capacity management.

FIG. 3 illustrates additional example operations of the system disclosed herein for providing a protocol between the system and the drives for capacity management.

FIG. 4 illustrates alternative example operations of the system disclosed herein for providing a protocol between the system and the drives for capacity management.

FIG. 5 illustrates an example processing system that may be useful in implementing the described technology.

### DETAILED DESCRIPTION

Storage devices, such as disc drives are provisioned to withstand the worst case scenarios. For example, a disc drive may be formatted to provide adequate performance and reliability in worst case temperature, vibration, etc. As a result, in more typical ordinary working conditions, which are generally not the worst-case conditions, the disc drives may be operating sub-optimally or with lower efficiency than otherwise possible in terms of capacity, performance, reliability, etc. For example, formatting the disc drive for the worst-case scenario may result in areal density capacity (ADC) of the disc drive to be significantly lower than maximum potential in ordinary operating conditions because the Tracks-Per-Inch spacing of data tracks must include additional spacing safeguards against possible worst-case vibration conditions. For another example, the formatting of the disc drive for the worst-case scenario may result in reduced performance and ADC because the Bit-Per-Inch is lower than maximum potential to safeguard against possible worst-case temperature conditions that may degrade reader performance. Moreover, the formatting of the disc drive may include safeguards against cold temperatures, such as those experienced in telecommunications or surveillance equipment, and these cold temperatures may never be experienced within a server in a data center.

The technology disclosed herein relates to capacity management for disc drives based on various parameters related to the disc drive, including position of drives in the chassis, distance of the drive from any cooling system, potential vibration levels experienced by the drive, expected worse-case temperatures, etc. These parameters may be saved on a lookup table and the capacity and utilization parameters of the drive may be set based on the parameters. Thus, for example, if a drive is installed in the chassis further from a cooling fan, the areal density of the drive may be set higher than if the drive is set closer to the cooling fan, etc.

Specifically, the solution disclosed herein uses information about the chassis capability as well as the drives' position and capabilities to improve the performance of disc drives based on location of the drive in the chassis. Example implementations disclosed herein creates protocols and process for a system and the drives in a chassis to better understand the location of various drives in the chassis of a storage enclosure. Such protocols may also allow the system to understand the functions that are performed at the storage drives. Subsequently, the information about the drive location, functions, etc., is used to enable different features, format the drives, etc., in a manner such that the drives' capacity and capability are used more efficiently. For example, implementations disclosed herein provides for storage enclosures to maintain tables that store parameters of the disc drives in the storage enclosure and expose these tables to the system via sets of protocols and processes between the system and the storage enclosure.

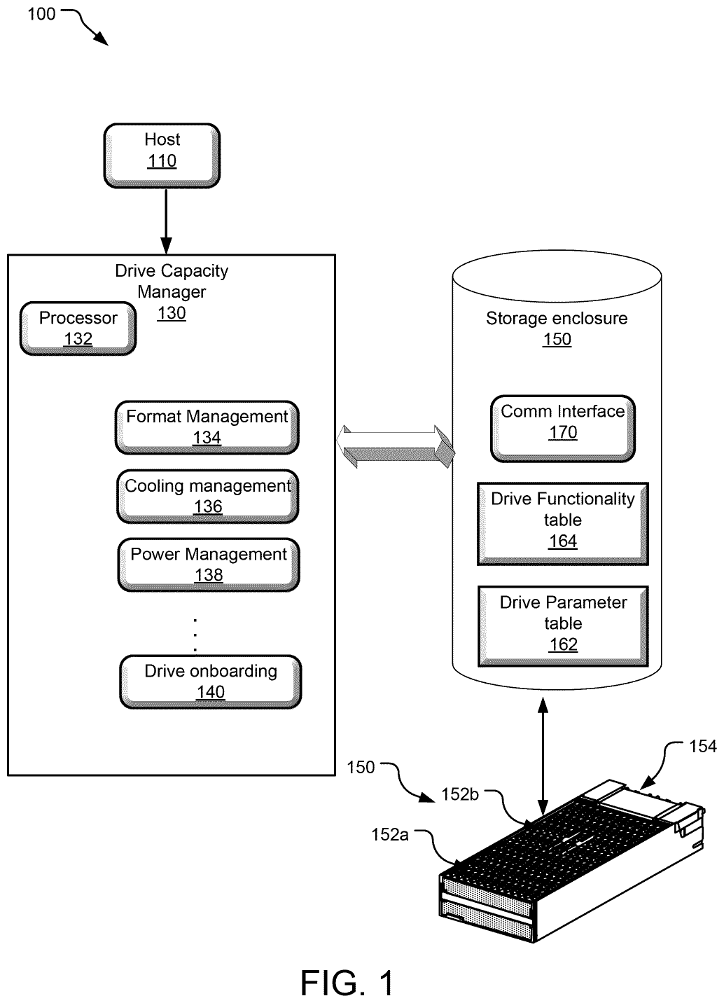

FIG. 1 illustrates an example schematic diagram of a system 100 implementing a protocol between a system and drives for drive capacity management. Specifically, the system 100 may include a host 110 that is communicatively connected with a storage enclosure 150. The host 100 may be a computing system such as a web server, a database server, a personal computer, etc. The storage enclosure 150 may include a number of storage devices such as magnetic storage drives, optical storage drives, Flash storage devices, etc. In one implementation, the storage drives 152a, 152b, etc., are organized on blades in a chassis of the storage enclosure 150. Furthermore, the storage enclosure 150 may also include a number of other enclosure components 154 such as a power supply unit (PSU), cooling fans, liquid cooling hardware, cold plates, Input/Output controllers, etc.

In the illustrated implementation, the enclosure components 154 are illustrated as configured on the back end of the storage enclosure 150. However, in alternative implementations, the enclosure components may be physically located in other parts of the storage enclosure 150. Irrespective of the configuration of the enclosure components 154 in the storage enclosure 150, some of the storage drives 152a, 152b may be affected differently by the operation of such enclosure components 154 compared to other of the storage drives 152a, 152b. For example, in the illustrated implementation, the storage drive 152a is further away from the enclosure components 154 compared to the storage drive 154b. As a result, the storage drive 152a may be exposed to less heat dissipated by a PSU of the storage enclosure 150. Similarly, the storage drive 152a may be exposed to less vibration and acoustic pressure generated by a cooling fan of the storage enclosure 150.

Given the differences in the position and operating condition parameters experienced by the different drives 152a, 152b, the reliability and performance of the different drives in performing various storage functions may also be different. For example, if the storage drive 152a is experiencing lower vibration, it may perform storage functions that are affected by the drive vibrations at higher fidelity compared to the storage drive 152b that is experiencing higher vibration. Similarly, if the storage drive 152b is cooled more quickly, it may be more efficient, performant, and/or reliable in executing storage operations compared to the storage drive 152a that is cooled less quickly.

Given these differences, the system disclosed herein provides for a protocol between a system and the storage drives 152 to manage the configuration and/or operation of the storage drives 152 based on various parameters of the storage drives 152 and their position in the system 154. Specifically, the storage enclosure 150 may be configured to store various parameters about the storage drives. In the illustrated implementation, the storage enclosure 150 provides a drive parameter table 162 that stores various parameters of the storage drives 152 such as the location of the storage drives in the storage enclosure 150, the maximum vibration experienced by the storage drives 152, the average vibration experienced by the storage drives 152, the maximum temperature experienced by the storage drives 152, the minimum temperature experienced by the storage drives, the average temperature experienced by the storage drives, voltage drops from PSU to drive, etc.

Furthermore, in the illustrated implementation, the storage enclosure 150 also provides for a drive functionality table 164 that stores various functionalities of the storage drives 152. For example, the drive functionality table 164 may specify that the storage drive 152a is used predominantly for data reading operations whereas storage drive 152b is used predominantly for data writing operations. Alternatively, the drive functionality table 164 may specify that the storage drive 152a predominantly stores sequentially-accessed data, such as video data that may require lower fidelity whereas storage drive 152b predominantly stores randomly-accessed transactional data, such as system metadata, and therefore requires higher fidelity of reading and writing operations.

A communication interface 170 of the storage enclosure 150 may be available to expose the drive parameter table 162, the drive functionality table, and other data regarding the storage drives 152 to other systems communicatively connected to the storage enclosure 150. In the illustrated implementation, the storage enclosure 150 is communicatively connected to a drive capacity manager 130. While the drive capacity manager 130 is illustrated to be external to the storage enclosure and to a host 110, in alternative implementation, the drive capacity manager 130 may be implemented on the host 110, on the storage enclosure 150, or at other location such as on a cloud server that is communicatively connected to the host 110 and the storage enclosure 150. Communication between host and drive can happen in-band, such as over the primary storage interface, or out-of-band, such as on a secondary side-band interface.

The drive capacity manager 130 may include a processor 132 configured to execute various instructions for managing the capacity of the various drives 152 in the storage enclosure 150. The drive capacity manager 130 may store various format management instructions 134, cooling management instructions 136, power management instructions 138, etc. For example, the drive capacity management instructions 136 may determine, based on the various information from the drive functionality table 164 and the drive parameter table 162, the capacity at which drives 152 are to be formatted. Thus, the format management instructions 134 may be processed to set formatting of the drive 152a to be set at a higher capacity given its position away from the fan. On the other hand, the format management instructions 134 may be processed to set formatting of the drive 152b to be set at a lower capacity given its position and other parameters.

The cooling management instructions 136 may be processed to set the rotational speed of the cooling fan(s); the flow-rate, the volume, and/or the temperature of fluidic (liquid) cooling; etc., based on the workload on the drives 152, the position of the drives 152, and other drive parameters and/or functionality. Similarly, the power management instructions 138 may be executed to set the power level of the PSU or other power source based on the workload on the drives 152, the position of the drives 152, and other drive parameters and/or functionality. In another implementation, the power level of the drive 152 can also be managed based on the work-load on the drive.

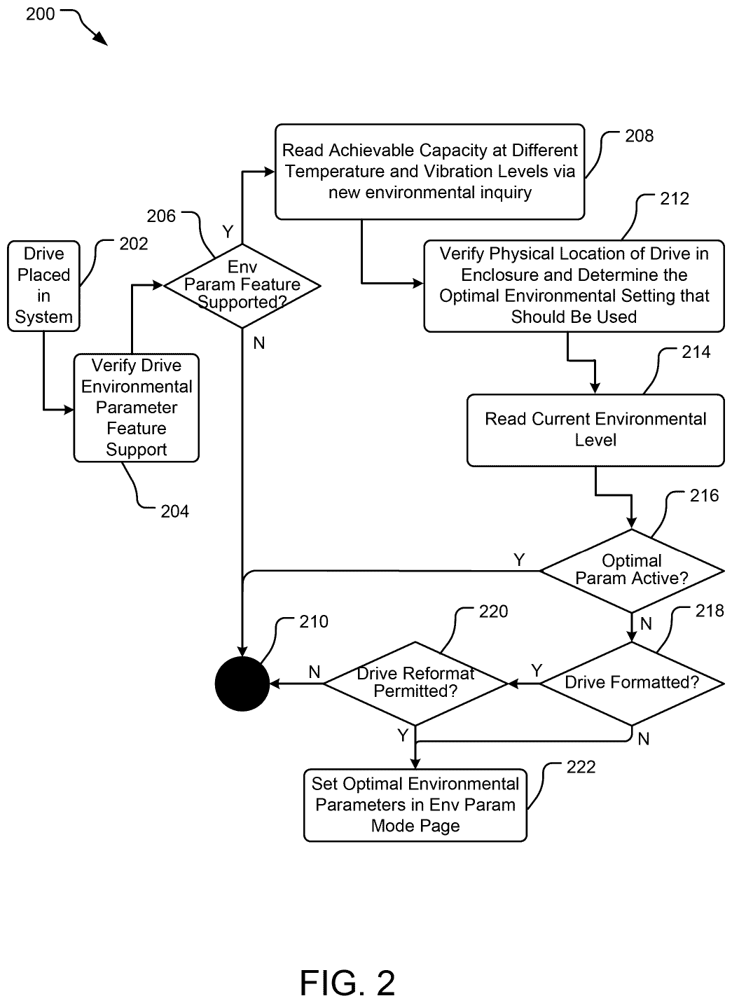

The drive capacity manager 130 may also store various drive onboarding instructions 140 that when processed can cause the drive capacity manager 130 to communicate with the storage enclosure 150, the storage drives 152, the drive functionality table 164, the drive parameter table 162, etc., to determine if the drives 152 support the features of the technology disclosed herein. FIG. 2 below illustrates operations of one or more of the various computer process instructions 134-140 that may be stored in the drive capacity manager.

In an alternative implementation of the system 100, the protocol between the drives 152 and the drive capacity manager 130 may be two ways. For example, with the drive capacity manager 130 implemented with the chassis of the storage enclosure 150, the drives 152 can communicate to the drive capacity manager 130 requesting one or more features. For example, the drive 152a can request a fan speed to be adjusted in response to receiving an operation that requires lower vibration. Similarly, a drive 152b can send the drive capacity manager 130 to request additional cooling when it senses higher temperature or when it needs to perform an operation that requires cooler temperature.

In another alternative implementation, the PSU of the storage enclosure 150 may also communicate with the drive capacity manager 130 to change its operating parameter such as, for example, a power-up state, a power-down state, etc. In yet another implementation, the drives 152b can communicate with each other based on one or more functions and request the drive capacity manager 130 to change the operating parameter accordingly. For example, the drives 152a and 152b may communicate with each other respect to their respective storage functions and current operating conditions such as temperature, vibration, etc. Subsequently, based on such communication the drives may request a change to fan speed, cooling, etc., from the drive capacity manager 130. Alternatively, the drives 152a and 152b may adjust their own operations to adjust the vibrations, heat levels, power consumptions, etc.

In one embodiment with drives 152 performing read after write operations to verify the data and increase density, the verification of the drives 152 could send to the system the verification of the data written. This data can then be used to determine the level of duplication required as well as confidence in the data stored. Depending on the read after write verification a confidence level of the data rather than a binary value can also be sent. If the data is not properly written further features like which sectors or parts of sectors are not properly written can be shared with the system and the system can work on creating outer codes and duplicating the data elsewhere.

Now referring to FIG. 2, it illustrates operations 200 of the system disclosed herein for providing a protocol between the system and the drives for capacity management. Specifically, at operation 202 the system determines that a new drive is placed in the system. In response, an operation 204 verifies whether the newly placed drive supports the feature for capacity management based on environmental parameters. An operation 206 determines that if the newly placed drive supports the feature for capacity management based on environmental parameters, control should be transferred to operation 208 and if not, the control should be transferred to 210.

At the operation 208 reads environmental parameter table that may provide achievable capacity of the drive at different environmental parameters. For example, the operation 208 may read achievable capacity of the drive at different vibration and temperature levels by executing a new environmental inquiry. Subsequently, an operation 212 verifies physical location of the drive in the storage enclosure and determines the optimal environmental settings that should be used for the drive. An operation 214 may read the current environmental level from a new environment parameter table.

An operation 216 determines if the settings of the drive are at the optimal parameter levels. If yes, the control is transferred to operation 210. If the settings of the drive are not at the optimal parameter levels, an operation 218 determines if the drive is formatted. If the drive is formatted, control passes to operation 220, otherwise, the control is transferred to operation 222. The operation 220 determines if reformatting of the drive is permitted. If so, an operation 222 sets optimal environmental parameters in an environment parameter mode page and the drive is reformatted to the new parameters.

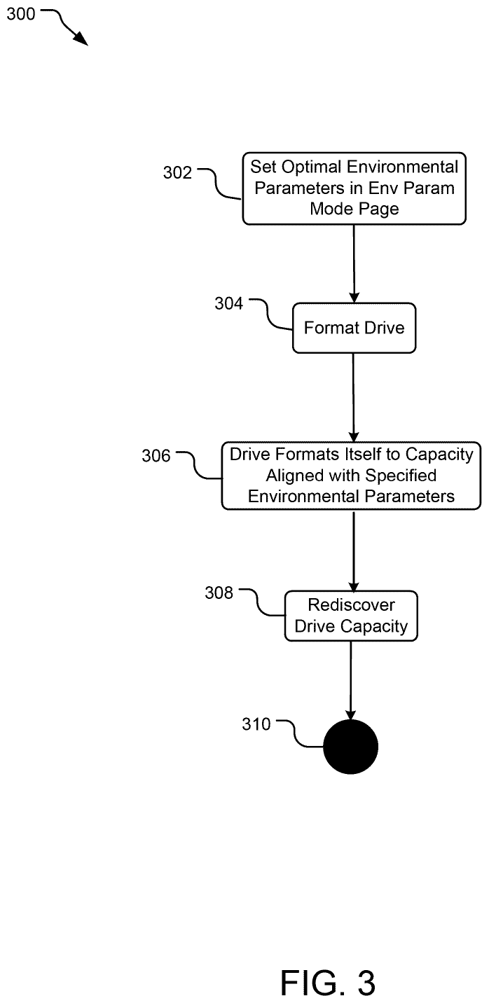

FIG. 3 illustrates additional operations 300 of the system disclosed herein for providing a protocol between the system and the drives for capacity management. Specifically, operation 302 illustrates the operation 222. Subsequently, an operation 304 sends drive format instruction to the drive, such as a SCSI “Format Unit” command. An operation 306, in response to the drive format instruction, the drive formats itself to the capacity aligned with the specified environmental parameters. At operation 308, the system may rediscover the drive capacity as per the updated capacity settings.

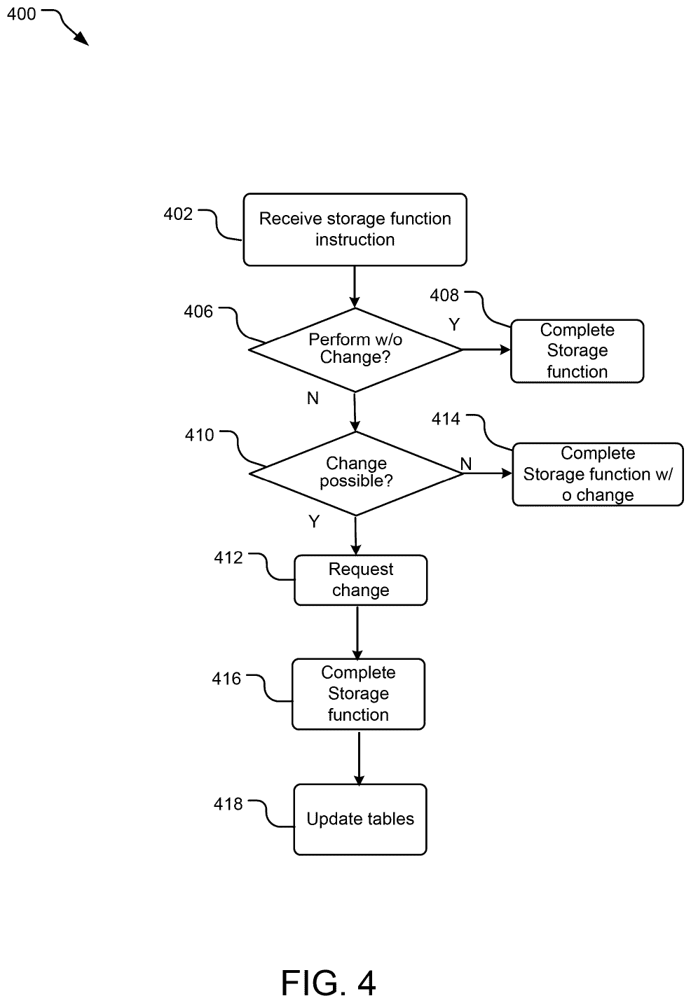

FIG. 4 illustrates alternative operations 400 of the system disclosed herein for providing a protocol between the system and the drives for capacity management. Specifically, FIG. 4 illustrates operations where the system determines to change the drive operating and/or environmental parameter based on storage functions for one or more of the storage drives. For example, an operation 402 may receive instructions for storage to a drive to perform a write operation. In response, an operation 406 determines if the write operation is to be performed without any change to drive operating parameters. If so, an operation 408 completes the storage function.

If the operation is to be performed with a change, such as for example, change in the fan speed, a change in the power level, etc., an operation 410 determines if such change to the operating parameter is possible. If such change is not possible, an operation 412 requests that appropriate change, such as the change to the cooling fan, change to the cooling sprayer, change to the power level, etc. Subsequently, an operation 416 completes the storage function and an operation 418 may change one or more tables as appropriate.

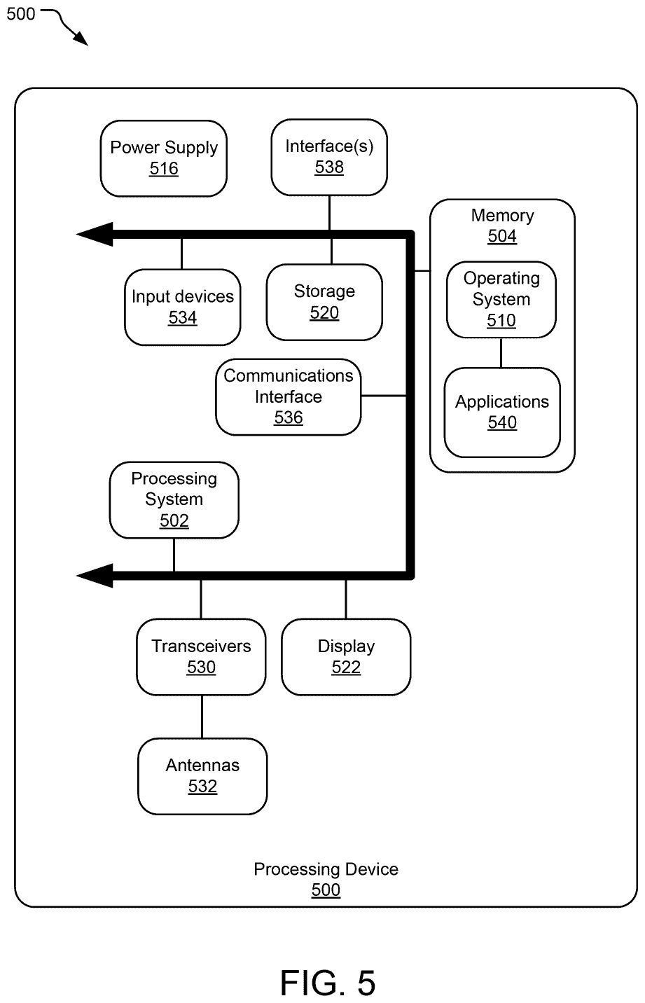

FIG. 5 illustrates an example processing system 500 that may be useful in implementing the described technology. The processing system 500 is capable of executing a computer program product embodied in a tangible computer-readable storage medium to execute a computer process. Data and program files may be input to the processing system 500, which reads the files and executes the programs therein using one or more processors (CPUs or GPUs). Some of the elements of a processing system 500 are shown in FIG. 5 wherein a processor 502 is shown having an input/output (I/O) section 504, a Central Processing Unit (CPU) 506, and a memory section 508. There may be one or more processors 502, such that the processor 502 of the processing system 500 comprises a single central-processing unit 506, or a plurality of processing units. The processors may be single core or multi-core processors. The processing system 500 may be a conventional computer, a distributed computer, or any other type of computer. The described technology is optionally implemented in software loaded in memory 508, a storage unit 512, and/or communicated via a wired or wireless network link 514 on a carrier signal (e.g., Ethernet, 3G wireless, 8G wireless, LTE (Long Term Evolution)) thereby transforming the processing system 500 in FIG. 5 to a special purpose machine for implementing the described operations. The processing system 500 may be an application specific processing system configured for supporting a distributed ledger. In other words, the processing system 500 may be a ledger node.

The I/O section 504 may be connected to one or more user-interface devices (e.g., a keyboard, a touch-screen display unit 518, etc.) or a storage unit 512. Computer program products containing mechanisms to effectuate the systems and methods in accordance with the described technology may reside in the memory section 508 or on the storage unit 512 of such a system 500.

A communication interface 524 is capable of connecting the processing system 500 to an enterprise network via the network link 514, through which the computer system can receive instructions and data embodied in a carrier wave. When used in a local area networking (LAN) environment, the processing system 500 is connected (by wired connection or wirelessly) to a local network through the communication interface 524, which is one type of communications device. When used in a wide-area-networking (WAN) environment, the processing system 500 typically includes a modem, a network adapter, or any other type of communications device for establishing communications over the wide area network. In a networked environment, program modules depicted relative to the processing system 500 or portions thereof, may be stored in a remote memory storage device. It is appreciated that the network connections shown are examples of communications devices for and other means of establishing a communications link between the computers may be used.

In an example implementation, a user interface software module, a communication interface, an input/output interface module, a ledger node, and other modules may be embodied by instructions stored in memory 508 and/or the storage unit 512 and executed by the processor 502. Further, local computing systems, remote data sources and/or services, and other associated logic represent firmware, hardware, and/or software, which may be configured to assist in supporting a distributed ledger. A ledger node system may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 508 and/or the storage unit 512 and executed by the processor 502.

The processing system 500 may be implemented in a device, such as a user device, storage device, IoT device, a desktop, laptop, computing device. The processing system 500 may be a ledger node that executes in a user device or external to a user device.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared, and other wireless media.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method, comprising:
determining a location of a storage device in a storage enclosure;
based on the location of a storage device in a storage enclosure, determining environmental parameters associated with the location of the storage device;
determining achievable capacity of the storage device based on the environmental parameters associated with the location of the storage device; and
formatting the storage device based on the determined achievable capacity.

2. The method of claim 1, wherein the storage device is a disc drive.

3. The method of claim 1, wherein the environmental parameters include at least one of temperature and vibration at the location of the storage device in the enclosure.

4. The method of claim 1, wherein formatting the storage device based on the determined achievable capacity further comprising formatting the areal density capacity (ADC) of the storage device based on the determined achievable capacity.

5. The method of claim 1, wherein determining the location of a storage device in a storage enclosure further comprising receiving an advertisement packet from the storage device newly configured in the storage enclosure.

6. The method of claim 1, further comprising:
receiving from the storage device, information regarding a write operation to be performed by the storage device;
determining an environmental parameter required for performing the write operation; and
adjusting an operational parameter of the storage enclosure based on the environmental parameter required for performing the write operation.

7. The method of claim 6, wherein the environmental parameter is the vibration level and the operational parameter is speed of a cooling fan.

8. The method of claim 6, wherein the environmental parameter is the temperature level and the operational parameter is level of fluidic cooling.

9. In a computing environment, a method performed at least in part on at least one processor, the method comprising:
determining a location of a storage device in a storage enclosure;
based on the location of a storage device in a storage enclosure, determining environmental parameters associated with the location of the storage device;
determining achievable capacity of the storage device based on the environmental parameters associated with the location of the storage device; and
formatting the storage device based on the determined achievable capacity.

10. The method of claim 9, wherein the storage device is a disc drive.

11. The method of claim 9, wherein the environmental parameters include at least one of temperature and vibration at the location of the storage device in the enclosure.

12. The method of claim 9, wherein formatting the storage device based on the determined achievable capacity further comprising formatting the areal density capacity (ADC) of the storage device based on the determined achievable capacity.

13. The method of claim 9, wherein determining the location of a storage device in a storage enclosure further comprising receiving an advertisement packet from the storage device newly configured in the storage enclosure.

14. The method of claim 9, further comprising:
receiving from the storage device, information regarding a write operation to be performed by the storage device;
determining an environmental parameter required for performing the write operation; and
adjusting an operational parameter of the storage enclosure based on the environmental parameter required for performing the write operation.

15. The method of claim 14, wherein the environmental parameter is the vibration level and the operational parameter is speed of a cooling fan.

16. The method of claim 14, wherein the environmental parameter is the temperature level and the operational parameter is level of fluidic cooling.

17. One or more tangible computer-readable storage media encoding computer-executable instructions for executing on a computer system a computer process, the computer process comprising:
determining a location of a storage device in a storage enclosure;
based on the location of a storage device in a storage enclosure, determining environmental parameters associated with the location of the storage device;
determining achievable capacity of the storage device based on the environmental parameters associated with the location of the storage device; and
formatting the storage device based on the determined achievable capacity.

18. One or more tangible computer-readable storage media of claim 17, wherein the environmental parameters include at least one of temperature and vibration at the location of the storage device in the enclosure.

19. One or more tangible computer-readable storage media of claim 15, wherein formatting the storage device based on the determined achievable capacity further comprising formatting the areal density capacity (ADC) of the storage device based on the determined achievable capacity.

20. One or more tangible computer-readable storage media of claim 17, wherein the computer process further comprising:
receiving from the storage device, information regarding a write operation to be performed by the storage device;
determining an environmental parameter required for performing the write operation; and
adjusting an operational parameter of the storage enclosure based on the environmental parameter required for performing the write operation.
